(19) United States
(12) Patent Application Publication
(10) Pub. No.: US 2015/0281839 A1
(43) Pub. Date: Oct. 1, 2015

(54) BACKGROUND NOISE CANCELLATION USING DEPTH

(71) Applicants: David BAR-ON, Givat Ella (IL); Ravishankar BALAJI, Mountain View, CA (US)

(72) Inventors: David BAR-ON, Givat Ella (IL); Ravishankar BALAJI, Mountain View, CA (US)

(21) Appl. No.: 14/231,031

(22) Filed: Mar. 31, 2014

(51) Int. Cl. H04R 3/00

(52) U.S. Cl. CPC H04R 3/002

(57) ABSTRACT

An apparatus, system, and method for reducing noise by using a depth map is disclosed herein. The method includes detecting a plurality of audio signals. The method includes obtaining depth information and image information and creating a depth map. The method further includes determining a primary audio source from a number of audio sources in the depth map. The method also includes removing noise from the audio signals originating from the primary audio source.

### BACKGROUND NOISE CANCELLATION USING DEPTH

1. Technical Field

The present techniques relate generally to background noise cancellation: More specifically, the present techniques relate to the cancellation of noise from background voices using a depth map.

2. Background Art

A computing device may use beamforming with two microphones to focus on an audio source, such as a person speaking. A parameter sweep approach may be followed by some primary speaker detection criteria to estimate the location of the speaker. Blind source separation (BSS) technologies may also be used to clean an audio signal of unwanted voices or noises. Echo cancellation may also be used to further cancel noise.

### BRIEF DESCRIPTION OF THE DRAWINGS

FIG. 1 is a block diagram of a computing device that may be used for noise cancellation;

FIG. 2 is an illustration of a computing device for noise cancellation being used in an environment with two people as audio sources;

FIG. 3 is an illustration of a system for noise cancellation using a beam former;

FIG. 4 is a diagram of an exemplary computing device for noise cancellation using a feedback beamformer;

FIG. 5 is an illustration of two different orientations of microphones;

FIG. 6 is an illustration of a computing device with a camera and microphones, and an accelerometer to detect movement of the camera relative to the microphones;

FIG. 7 is a process flow diagram of an example method for reducing noise by using a depth map; and

FIG. 8 is a block diagram showing tangible, machine-readable media that store code for cancelling noise.

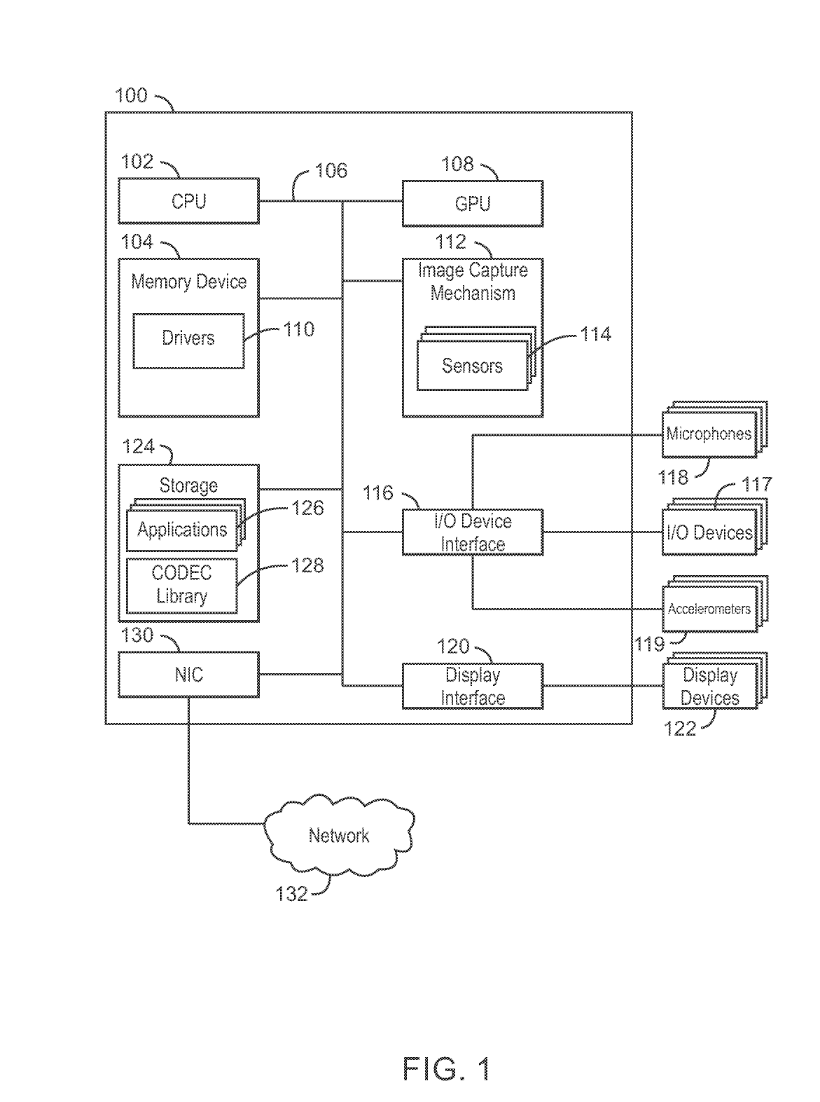

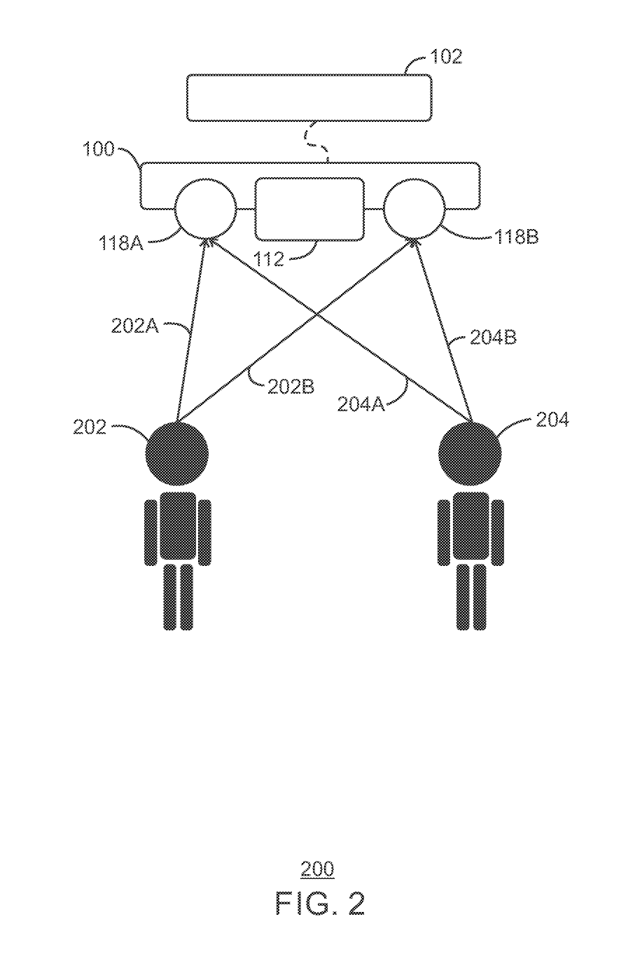

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

As discussed above, in locating the source of audio to be beam formed for example, a parameter sweep approach may be used where the two or more microphone signals are cross correlated in time to find matches between the two signals, without a priori knowledge on the expected optimal delay that can be obtained from the depth camera. The parameter sweep may be followed by some primary speaker detection criteria to estimate the location of a primary speaker. However, such a feedback mechanism is slow and computationally intensive, thus not suitable for lower power real-time human-computer-interaction purposes. Furthermore, if there is more than one speaker, the detected source of audio may shift as one speaker stops talking and another speaker begins talking. Finally, the source of audio may not be stationary. For example, a speaker may walk around a room when giving a presentation. A parameter sweep approach may not be able to keep up with the movement of the speaker and thus result in inadequate noise cancellation.

Embodiments disclosed herein enable audio sources to be detected in a depth map that is created from depth information provided by a depth sensor or depth camera. The depth map may also be used to locate an audio source. The depth map may be used to track target audio sources by locating and updating their position within the depth map. In some embodiments, a primary audio source may be determined through facial recognition. As used herein, a primary audio source is a source of audio that is to have noise cancellation applied. In some embodiments, the primary audio source may also be tracked through facial recognition and body tracking. In some embodiments, multiple primary audio sources may be tracked concurrently.

Some embodiments may be implemented in one or a combination of hardware, firmware, and software. Further, some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of a computing device that may be used for noise cancellation. The computing device 100 may be, for example, a laptop computer, desktop computer, ultrabook, tablet computer, mobile device, or server, among others. The computing device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the computing device 100 may include more than one CPU 102. The memory device 104 can include random access memory (RAM), read only memory (ROM), flash memory, or any other suitable memory systems. For example, the memory device 104 may include dynamic random access memory (DRAM).

The computing device 100 may also include a graphics processing unit (GPU) 108. As shown, the CPU 102 may be coupled through the bus 106 to the GPU 108. The GPU 108 may be configured to perform any number of graphics operations within the computing device 100. For example, the GPU 108 may be configured to render or manipulate graphics images, graphics frames, videos, or the like, to be displayed to a user of the computing device 100. In some embodiments, the GPU 108 includes a number of graphics engines (not shown), wherein each graphics engine is configured to perform specific graphics tasks, or to execute specific types of workloads. For example, the GPU 108 may include an engine that produces variable resolution depth maps. The particular resolution of the depth map may be based on an application.

The memory device 104 can include random access memory (RAM), read only memory (ROM), flash memory, or any other suitable memory systems. For example, the memory device 104 may include dynamic random access memory (DRAM). The memory device 104 may include a device driver 110 that is configured to execute the instructions for encoding depth information. The device driver 110 may be software, an application program, application code, or the like.

The computing device 100 includes an image capture mechanism 112. In embodiments, the image capture mechanism 112 is a camera, depth camera, stereoscopic camera, infrared sensor, or the like. For example, the image capture mechanism may include, but is not limited to, a stereo camera, time of flight sensor, depth sensor, depth camera, structured light camera, a radial image, a 2D camera time sequence of images computed to create a multi-view stereo reconstruction, or any combinations thereof. The image capture mechanism 112 is used to capture depth information and image texture information. Accordingly, the computing device 100 also includes one or more sensors 114. In examples, a sensor 114 may be a depth sensor 114. The depth sensor 114 may be used to capture the depth information associated with a source of audio. In some embodiments, a driver 110 may be used to operate a sensor within the image capture device 112, such as the depth sensor 114. The depth sensor 114 may capture depth information by altering the position of the sensor such that the images and associated depth information captured by the sensor is offset due to the motion of the camera. In a single depth sensor implementation, the images may also be offset by a period of time. Additionally, in examples, the sensors 114 may be a plurality of sensors. Each of the plurality of sensors may be used to capture images that are spatially offset at the same point in time. A sensor 114 may also be an image or depth sensor 114 used to capture image information for facial recognition and body tracking. Furthermore, the image sensor may be a charge-coupled device (CCD) image sensor, a complementary metal-oxide-semiconductor (CMOS) image sensor, a system on chip (SOC) image sensor, an image sensors with photosensitive thin film transistors, or any combination thereof. The device driver 110 may encode the depth information using a 3D mesh and the corresponding textures from the image texture information in any standardized media CODEC, currently existing or developed in the future.

The CPU 102 may also be connected through the bus 106 to an input/output (I/O) device interface 116 configured to connect the computing device 100 to one or more I/O devices 117, microphones 118, and accelerometers 119. The I/O devices 117 may include, for example, a keyboard and a pointing device, wherein the pointing device may include a touchpad or a touchscreen, among others. The I/O devices 117 may be built-in components of the computing device 100, or may be devices that are externally connected to the computing device 100. In some examples, microphones 118 may be two or more microphones 118. The microphones 118 may be directional. In some examples, accelerometers 119 may be two or more accelerometers that are built into the computing device. For example, one accelerometer may be built into each surface of a laptop. In some examples, the memory 104 may be communicatively coupled to sensor 114 and the plurality of microphones 118 through direct memory access (DMA).

The CPU 102 may also be linked through the bus 106 to a display interface 120 configured to connect the computing device 100 to a display device 122. The display device 122 may include a display screen that is a built-in component of the computing device 100. The display device 122 may also include a computer monitor, television, or projector, among others, that is externally connected to the computing device 100.

The computing device also includes a storage device 124. The storage device 124 is a physical memory such as a hard drive, an optical drive, a thumbdrive, an array of drives, or any combinations thereof. The storage device 124 may also include remote storage drives. A number of applications 126 may be stored on the storage device 124. The applications 126 may include a noise cancellation application. The applications 126 may be used to perform beamforming based on a depth map. In some examples, the depth map may be formed from the environment captured by the image capture mechanism 112 of the computing device 100. Additionally, a codec library 128 may be stored on the storage device 124. The codec library 128 may include various codecs for the processing of audio data and other sensory data. A codec may be a software or hardware component of a computing device that can encode or decode a stream of data. In some cases, a codec may be a software or hardware component of a computing device that can be used to compress or decompress a stream of data. In embodiments, the codec library includes an audio codec that can process multi-channel audio data.

In some examples, beam forming is used to capture multi-channel audio data from the direction and distance of a targeted speaker. The multi-channel audio data may also be separated using blind source separation. Noise cancellation may be performed when one or more channels are selected from the multi-channel audio data after blind source separation has been performed. In addition, auto echo cancellation may also be performed on the one or more selected channels.

The computing device 100 may also include a network interface controller (NIC) 130. The NIC 130 may be configured to connect the computing device 100 through the bus 106 to a network 132. The network 132 may be a wide area network (WAN), local area network (LAN), or the Internet, among others.

The block diagram of FIG. 1 is not intended to indicate that the computing device 100 is to include all of the components shown in FIG. 1. Rather, the computing system 100 can include fewer or additional components not illustrated in FIG. 1 (e.g., sensors, power management integrated circuits, additional network interfaces, etc.). The computing device 100 may include any number of additional components not shown in FIG. 1, depending on the details of the specific implementation. Furthermore, any of the functionalities of the CPU 102 may be partially, or entirely, implemented in hardware and/or in a processor. For example, the functionality may be implemented with an application specific integrated circuit, in logic implemented in a processor, in logic implemented in a specialized graphics processing unit, or in any other device.

FIG. 2 is an illustration of a computing device 100 for noise cancellation being used in an environment with two people as audio sources. The computing device 100 has a depth camera 112 that may be used to create a depth map that includes person 202 and person 204. The configuration of the computing device 100, person 202, and person 204 in FIG. 2 is generally referred to by the reference number 200.

In the example of FIG. 2, person 202 may be, for example, a primary audio source 202 that provides audio to microphones 118A and 118B. The audio signals 202A and 202B from primary audio source 202 are to be recorded by microphones 118A and 118B, respectively, and noise in the recorded signals is then cancelled by processor 102. Person 204 may be, for example, a person that is also speaking and thus also providing resultant audio signals 204A and 204B to microphones 118A and 118B, respectively. In some examples, both the speech from person 202 and 204 may be recorded and processed and have noise cancellation applied separately. In some examples, more than two people may be present, any number of which may have may have their voice recorded and noise cancelled. With a system of n users and m microphones, a total of (m)×(n) audio signals may be processed.

The computing device 100 also has an image capture mechanism 112, which may be, for example, a depth camera 112. The depth camera 112 .may create a depth map of the scene in front of the computing device 100. The scene of FIG. 2 would include person 202 and person 204. In some examples, the processor 102 would use a facial recognition logic to automatically identify audio sources. In the example of FIG. 2, this may be person 202 and person 204. In some examples, an application within computing device 100 would allow the user to choose a primary audio source. This may be done, for example, by displaying an image of the depth map scene and allowing the user to select a primary audio source. In some examples, the noise cancellation application would be able to take advantage of the audio source location information to process the audio efficiently according to the preferences of the user.

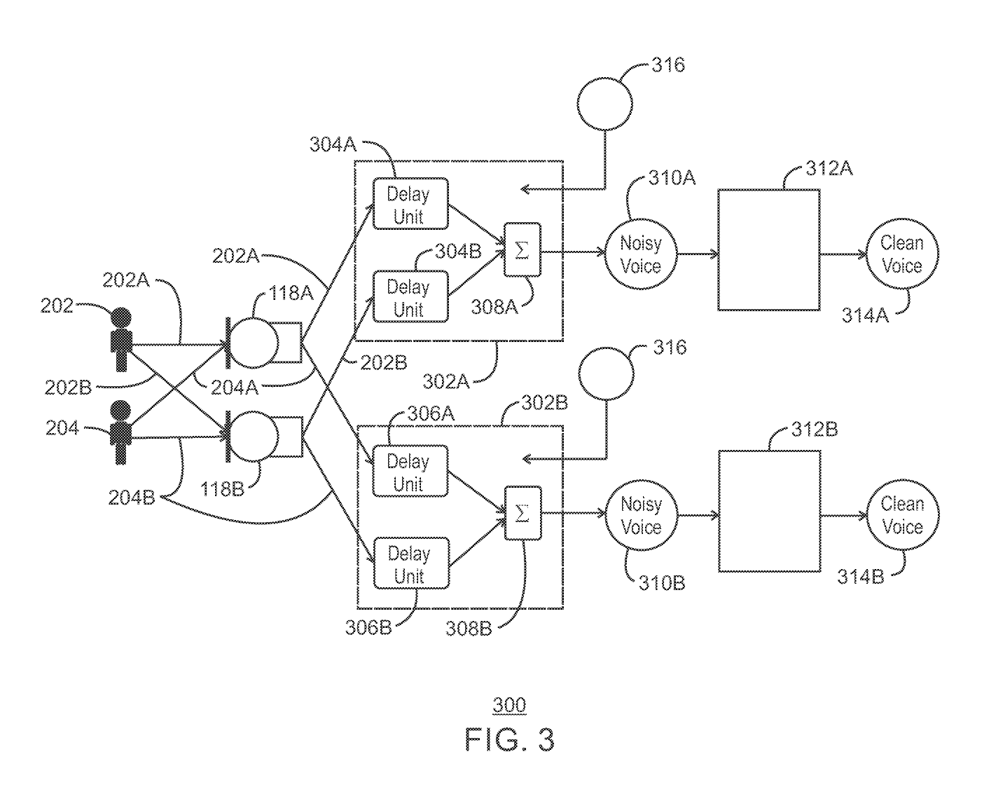

FIG. 3 is an illustration of a system 300 for noise cancellation using a beam former. The particular configuration of the system 300 includes at least a computing device similar to the computing device 100, a person 202, and a person 204 in FIG. 3. The two beamformer units 302A and 302B each contain respective delay units 304A, 304B, and 306A, 306B and summing units 308A and 308B. Noisy signals 310A and 310B are the unfiltered results of beam forming. In some examples, noisy signals 310A and 310B may be further processed by a denoiser 312A, 312B to produce clean signals 314A and 314B. A face detection unit 316 may provide a count and geometric coordinates of faces in the depth map scene.

In this example, beamformer units 302A and 302B may receive the audio signals from both person 202 and person 204 that are captured by microphones 118A and 118B. For example, audio signal 202A and audio signal 204A received by microphone 118A from person 202 and 204 are sent to delay units 304A and 306A, respectively, of the beamformer units 302A and 302B. Audio signals 202B and 204B received by microphone 118B are sent to delay units 304B and 306B, respectively, of beamformer unit 302B. In some examples, the count and geometric coordinates of the faces in the scene are supplied from the face detection unit 316. The delay units may then use the received coordinates to apply an appropriate time delay to the output signal of one of the microphones to re-construct the audio signal from the respective audio source.

For example, the beamformer unit 302A at the top of FIG. 3 may receive depth and location data from face detection unit 316 for audio source 202 and receive signals 202A and 202B from microphones 118A and 118B. The delay units 304A and 304B correct for the delay between the signals as received by microphones 118A and 118B and so that the signals are in phase with respect to the source audio 202. The signals 202A and 202B may then be summed together by the summing unit 308A of beamformer unit 302A to produce a noisy signal 310A in which the voice of audio source 202 is louder than in either signals 202A or 202B. In some examples, the noise may contain echoes of audio from audio source 204 among other noise. The audio from audio source 202 may still be accompanied by significant noise that, in some examples, may be further processed by a feedback beamformer unit 312A to produce a cleaner signal 314A.

In some examples, another beamformer unit 302B may simultaneously process a different audio source. In some examples, each beamformer unit 302A and 302B may correspond to each face detected by the face detection unit. For example, the beamformer unit 302B at the bottom of FIG. 3 may process signals 204A and 204B that originate from audio source 204. The noisy signal 310B produced by beamformer unit 302B may also be further processed by a denoiser 312B to produce cleaner signal 314B. In some examples, a beam former unit may be created for each face detected by the face detection logic.

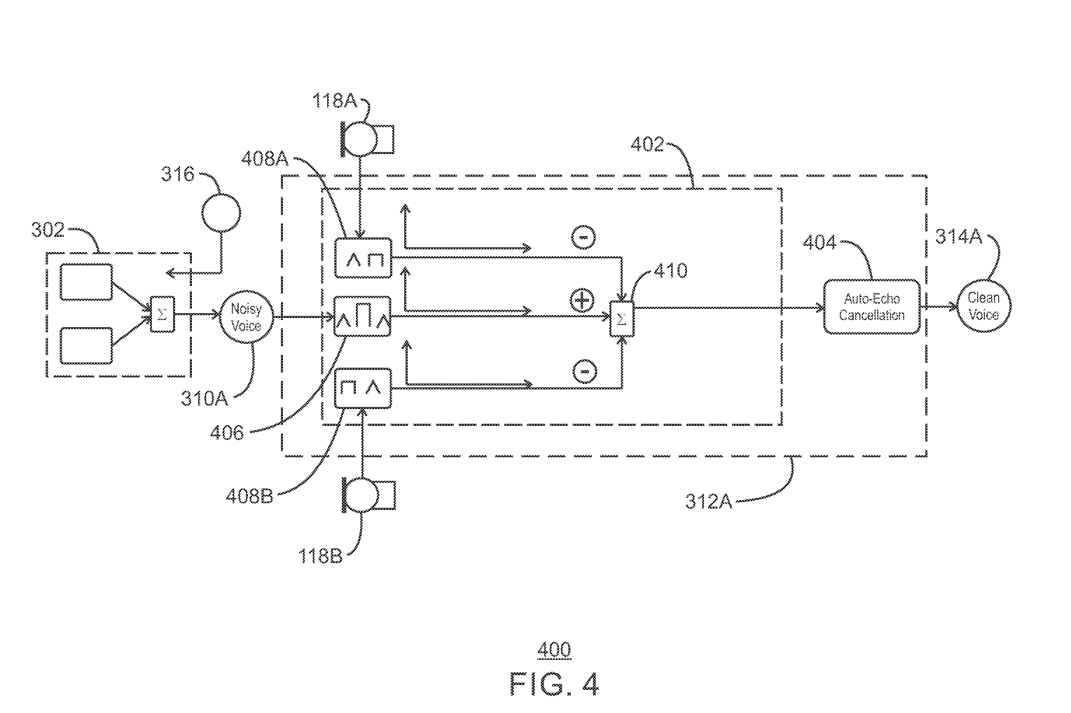

FIG. 4 is a diagram of an exemplary computing device 400 for noise cancellation using a feedback beamformer. In the example of FIG. 4, the noisy signal 310A is to be de-noised by the denoiser module 312A to produce a cleaner signal 314A. In some examples, this may be applied to noisy signal 310B or any number of other signals. For example, a feedback beamformer 402 may be created for each face detected by face detection unit 316 in a depth map scene. In some examples, the denoiser 312A may have a feedback beamformer unit 402. In some examples, the denoiser 312A may include an auto-echo cancellation unit 404.

In the example of FIG. 4, feedback beamformer unit 402 receives noisy signal 310A. As shown in 406, the noisy signal contains a relatively loud voice signal of speaker 202 as indicated by the relatively tall box symbol, in addition to echoes of speaker 204 indicated by the smaller triangular symbols. In some examples, there may be a feedback beamformer unit 402 for each detected audio source. For example, a feedback beamformer unit may be created for each face detected by the face detection unit 316. Delayed signal 408A and delayed signal 408B are then subtracted from noisy signal 310A to produce signal 406 which is fed back to the summing unit 410. As shown in FIG. 4, delayed signal 408A contains the voice of speaker 202 as indicated by a box with an equally loud echo of speaker 204 indicated by a triangular symbol before the box symbol. Delayed signal 408B shows the triangular symbol after the box symbol, indicating that the echo from speaker 204 is shifted in time relative to the voice of speaker 202. In some examples, the resulting cleaner signal may then be further processed by auto-echo cancellation unit 404 to remove additional remaining noise. After being processed by denoiser 312A, the signal results in a clean signal 314A. In some examples, clean signal 314A may be a clear voice of person 202 speaking.

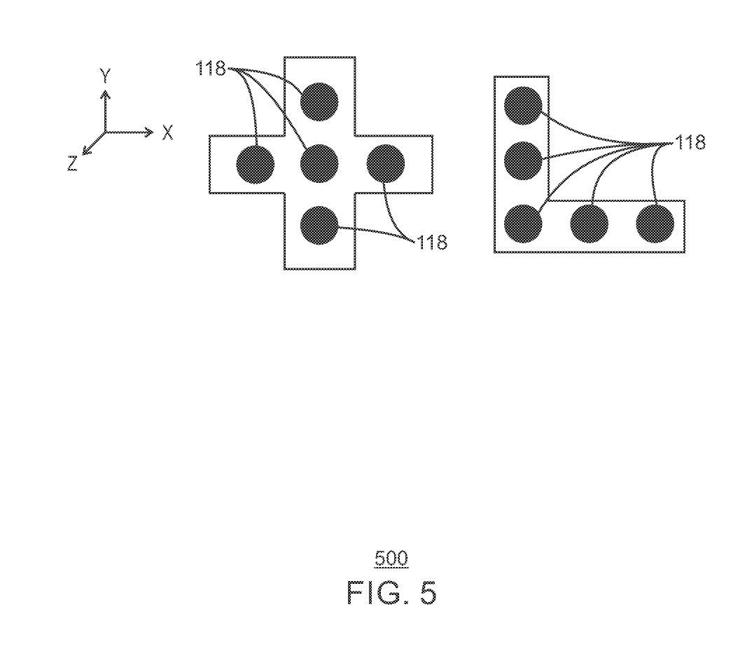

FIG. 5 is an illustration of two different orientations of microphones 118 in accordance with the embodiments disclosed herein. The microphones may be arranged to allow for relative X and Y axis offsets to be used in the processing of audio signals. In some examples, the microphones may be arranged in the form of a “plus” sign. In some examples, the microphones may be arranged in the shape of the letter “L.” There are many other possible configurations for the microphones, of which the two in FIG. 5 are only examples.

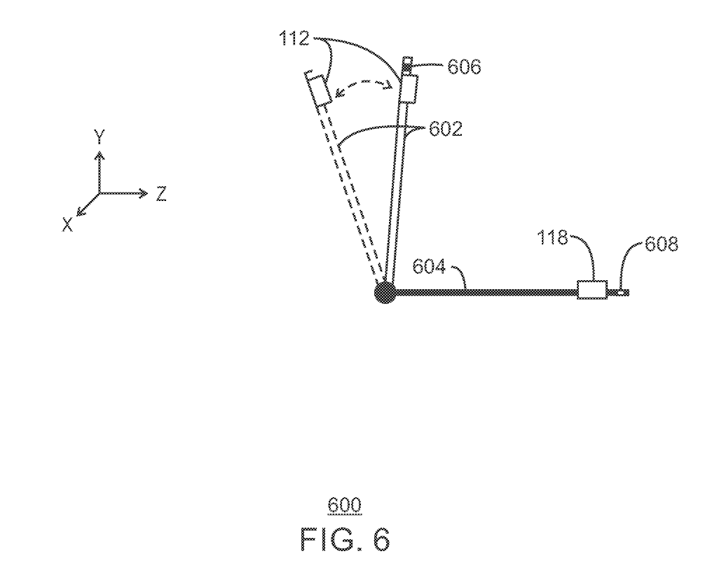

FIG. 6 is an illustration of a computing device 100 with a camera 112 and microphones 118, and two surfaces 602, 604 with two respective accelerometers 606, 608 to detect movement of the camera 112 relative to the microphones 118. Surface 602 and surface 604 may be two surfaces of a detachable, convertible, notebook, or laptop, for example. The accelerometer may be, for example, a gyroscope. The accelerometer measures change in the positions and orientation of surface 602 and surface 604 relative to each other. In some examples, a gyroscope may be used. A gyroscope may also measure change of surface 602 and surface 604 relative to Earth's gravity. The relative positions of camera 112 to the microphones 118 may be used in determining an appropriate delay to apply when beamforming and an appropriate angle at which to steer a beam along the “x” and “y” axes.

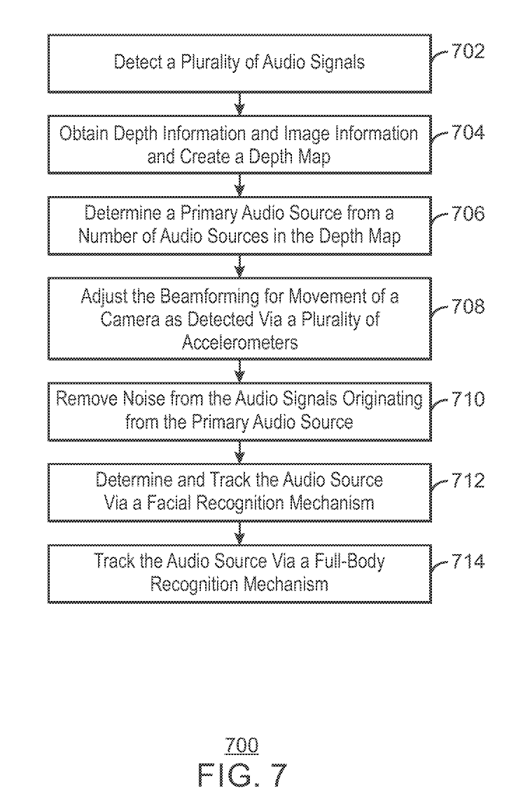

FIG. 7 is a process flow diagram of an example method for reducing noise by using a depth map. In various embodiments, the method 700 is used to cancel noise in captured audio signals. In some embodiments, the method 700 may be executed on a computing device, such as the computing device 100.

At block 702, a plurality of audio signals is detected. The audio signals may be detected via a plurality of microphones. In embodiments, any formation of microphones may be used. For example, a “plus” or letter “L” formation may be used. In some embodiments, blind source separation may also be used to separate the multi-channel audio data into several signals with spatial relationships. In some examples, blind source separation is an algorithm which separates a source signal with a spatial relationship to individual streams of audio data. Blind source separation may have as input a multi-channel audio source and provides multi-channel output, where the channels are separated based on their spatial relationships.

In some embodiments, the blind source separation may improve the signal-to-noise ratio (SNR) of each signal that is separated from the multi-channel audio data. In this manner, the separated multi-channel audio data may be immune to any sort of echo. An echo in audio data may be considered noise, and the result of the blind source separation algorithm is a signal that has a small amount of noise, resulting in a high SNR. Blind source separation may be executed in a power aware manner. In some embodiments, blind source separation may be triggered by a change in the multi-channel RAW audio data that is greater than some threshold. For example, the blind source separation algorithm may run in a low power state until the spatial relationships previously defined by the blind source separation algorithm no longer apply in the computational blocks discussed below.

At block 704, depth information and image information is obtained and a depth map is created. The depth information and image information may be obtained or gathered using an image capture mechanism. In embodiments, the depth information and image information may include the location, face and body features of a primary audio source. In some examples, the location may be recorded as a depth and angle of view. In some examples, the location may be recorded as coordinates. In some embodiments, the depth information and image texture information may be obtained by a device without a processing unit or storage.

At block 706, a primary audio source is determined from a number of audio sources in the depth map. The primary audio source may be determined by a user or predetermined criteria. For example, a user may choose a primary audio source from a graphical depth map display. In some examples, the primary audio source may be determined by a threshold volume level. In some examples, the primary audio source may be determined by originating from a preset location. Although a single primary audio source is described, a plurality of primary audio sources may be determined and processed accordingly. In embodiments, the location of the primary audio source is resolved with the phase correlation data and details of the microphone placements within the system. This location detail may be used in beamforming.

At block 708, the beamforming is adjusted for movement of a camera as detected by a plurality of accelerometers. In embodiments, an accelerometer may be attached or contained within each movable portion of a computing device. In some embodiments, the accelerometers may be gyroscopes.

In beamforming, if the voice signals received from the microphone are out of phase, they begin canceling out each other. If the signals are in phase, they will be amplified when summed. Beam forming will enhance the signals that are in phase and attenuate the signals that are not in phase. In particular, the beamforming module may apply beamforming to the primary audio source signals, using their location with respect to microphones of the computing device. Based on the location details calculated when the primary audio source location is resolved, the beam forming may be modified such that users does not need to be equidistant from each microphone. In some examples, weights may be applied to selected channels from the multi-channel RAW data based on the primary audio source location data.

At block 710, noise is removed from the audio signals originating from the primary audio source. In embodiments, removing noise may include beamforming the audio signals as received from a plurality of microphones. In some embodiments, removing noise may include using a feedback beamformer to further cancel noise. In some embodiments, an auto-echo cancellation unit may be used to further cancel noise.

At block 712, an audio source is determined and tracked via a facial recognition mechanism. Although one audio source is described, a plurality of audio sources may be determined and tracked via the facial recognition mechanism. In embodiments, one or more of these audio sources may selected as a primary audio source. For example, two primary audio sources may be determined and tracked by the facial recognition mechanism so that noise cancellation is applied to audio signals originating from the two primary audio sources.

At block 714, the audio source is tracked via a full-body recognition mechanism. In some embodiments, the full-body recognition mechanism may assume tracking from the facial recognition mechanism if a person's face is no longer detectable but their body is detectable. In some embodiments, the full-body recognition mechanism may detect and track audio sources in addition to the face facial recognition mechanism.

The process flow diagram of FIG. 7 is not intended to indicate that the blocks of method 700 are to be executed in any particular order, or that all of the blocks are to be included in every case. Further, any number of additional blocks may be included within the method 700, depending on the details of the specific implementation. For example, a depth map according to block 704 may be created prior to any audio signal being detected at block 702. In examples, block 710 may determine and track a potential audio source prior to block 702 detecting any audio signal. For example, the block of 712 may track audio sources using full-body recognition before detecting audio signals from each audio source.

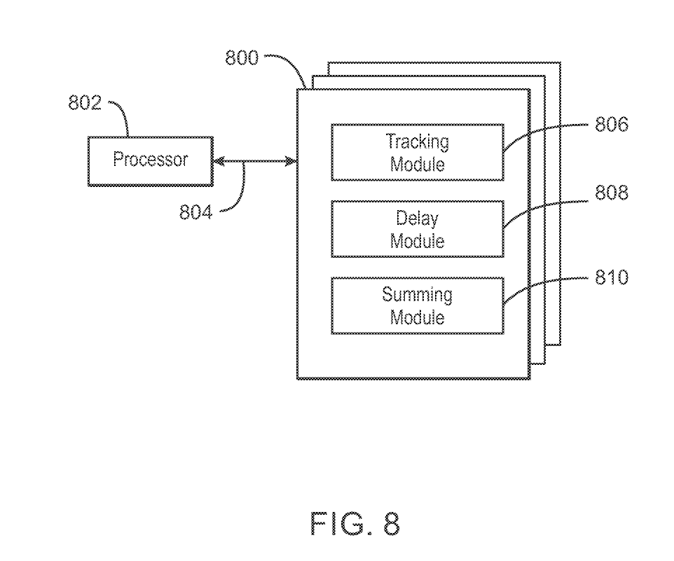

FIG. 8 is a block diagram showing a tangible, machine-readable media 800 that stores code for cancelling noise. The tangible, machine-readable media 800 may be accessed by a processor 802 over a computer bus 804. Furthermore, the tangible, machine-readable medium 800 may include code configured to direct the processor 802 to perform the methods described herein. In some embodiments, the tangible, machine-readable medium 800 may be non-transitory.

The various software components discussed herein may be stored on one or more tangible, machine-readable media 800, as indicated in FIG. 8. For example, a tracking module 806 may be configured create a depth map and tracking primary audio sources within a scene. In some examples, the tracking module 806 may use facial recognition to track the primary audio sources. In some examples, the tracking module 806 may use full-body recognition to track the primary audio sources. In some examples, the tracking module 806 may receive information from sensors to determine the origin of detected audio signals relative to a depth map. For example, tracking module 806 can receive information from a plurality of accelerometers to coordinate depth information from a depth sensor with audio signals to be captured by a plurality of microphones. A delay module 808 may be configured to receive a plurality of audio signals from the microphones and calculate a delay to apply to each signal based on primary audio source location information from tracking module 806. In some examples, the delay module separate the audio signals as captured from the microphones using blind source separation as discussed above. In some examples, a different delay may be applied to each audio signal depending on the primary audio source and the location of the primary audio source. A summing module 810 may be configured to add two or more signals together. In some examples, one or more of the signals may have a delay applied by the delay module 808. In some examples, an auto echo cancellation module (not shown) may also be included to remove noise from the processed audio signals.

The block diagram of FIG. 8 is not intended to indicate that the tangible, machine-readable media 800 is to include all of the components shown in FIG. 8. Further, the tangible, machine-readable media 800 may include any number of additional components not shown in FIG. 8, depending on the details of the specific implementation.

### EXAMPLE 1

A system for noise cancellation is described herein. The system includes a depth sensor. The system also includes a plurality of microphones. The system further includes a memory that is communicatively coupled to the depth sensor and plurality of microphones. The memory is to store instructions. The system includes a processor that is communicatively coupled to the depth sensor, the plurality of microphones and the memory. The processor is to execute the instructions. The instructions include detecting audio via the plurality of microphones. The instructions further include determining, using the depth sensor, a primary audio source from a number of audio sources. The instructions also include removing noise from the audio originating from the audio source.

The processor can process depth information from the depth sensor to determine the audio sources. The processor can process data from the depth sensor to determine and track the primary audio source by using facial recognition. The processor can further track the primary audio source using full body tracking. The system can include a noise filter that performs de-noising on the audio originating from the audio source. The instructions to be executed by the processor can include removing the noise using blind source separation. The microphones can be directional and the primary audio source can be focused on using beam forming. The depth sensor can be inside a depth camera. The memory can be communicatively coupled to the depth sensor and the plurality of microphones through direct memory access (DMA). The system can further include an accelerometer. The processor can be communicatively coupled to the accelerometer and can determine relative rotation and translation between the depth sensor and the microphones via the accelerometer.

### EXAMPLE 2

An apparatus for noise cancellation is described herein. The apparatus includes a depth camera. The apparatus includes a plurality of microphones. The apparatus further includes logic that at least partially includes hardware logic. The logic includes detecting audio via the plurality of microphones. The logic also includes determining a delay of the audio and a sum of the audio as detected by the plurality of microphones. The logic includes determining a primary audio source in the audio via the depth camera. The logic further includes cancelling noise in the primary audio source.

The logic can further include determining a relative rotation and relative translation between the depth camera and the plurality of microphones. The logic can also include tracking the primary audio source via the depth camera. The logic can include tracking the primary audio source using facial recognition. The logic can include tracking the primary audio source using full-body recognition. The logic can include cancelling the noise using a feedback beamformer. The logic can also include cancelling the noise comprises using auto echo cancellation. The logic can include cancelling the noise using a depth map. The logic can further include separating the audio using blind source separation. The apparatus can be a laptop, tablet device, or smartphone.

### EXAMPLE 3

A noise cancellation device is described here. The noise cancellation device includes at least one camera. The camera is to capture depth information. The noise cancellation device also includes at least two microphones. A delay of a sound is to be detected by the at least two microphones. The delay of the sound and the depth information is to be processed to identify a primary audio source of the sound and cancel noise from the sound.

The noise cancellation device can also include a beamforming unit to process the sound. The noise cancellation device can further include a noise cancellation module that is to cancel noise in the sound detected by the at least two microphones. The camera can further capture facial features that can be used to identify and track the primary audio source of the sound. The camera can further capture a full-body image that is tracked and can be used to identify the primary audio source of the sound. The noise cancellation device can include a feedback beamformer module to further cancel noise from the sound. The noise cancellation device can also include an echo cancellation module to further cancel noise from the sound. The noise cancellation device can include a plurality of accelerometers. The accelerometers can be used by the filter to determine relative rotation and relative translation between the camera and the microphones. The camera can be a depth camera. The noise cancellation device can further include a plurality of accelerometers and a tracking module. The accelerometers can be used by the tracking module to determine relative rotation and relative translation between the camera and the microphones.

### EXAMPLE 4

A method for noise cancellation is described herein. The method includes detecting a plurality of audio signals. The method also includes obtaining depth information and image information and creating a depth map. The method further includes determining a primary audio source from a number of audio sources in the depth map. The method also includes removing noise from the audio signals originating from the primary audio source.

The method can include beamforming the audio signals as received from a plurality of microphones. The method can further include determining and tracking the audio source via a facial recognition mechanism. The method can also include tracking the audio source via a full-body recognition mechanism. The method can include adjusting the beamforming for movement of a camera as detected via a plurality of accelerometers. The method can include processing the audio signals using feedback beamforming. The method can also include removing noise from the audio signals further by processing the audio signals using auto echo cancellation. The method can further include separating the audio signals using blind source separation. The method can also include focusing on the primary audio source using beamforming. The primary audio source can be a speaker and the noise can be background voices of other speakers.

### EXAMPLE 5

At least one tangible, machine-readable medium having instructions stored therein is described herein. The instructions, in response to being executed on a computing device, cause the computing device to detect a plurality of audio signals. The instructions further cause the computing device to obtain depth information and image information and create a depth map. The instructions also cause the computing device to determine a primary audio source from a number of audio sources in the depth map. The instructions further cause the computing device to remove noise from the audio signals originating from the primary audio source.

The instructions can cause the computing device to determine a primary audio source using facial recognition. The instructions can further cause the computing device to determine a primary audio source using full-body recognition. The instructions can further cause the computing device to track a primary audio source using facial recognition. The instructions can also cause the computing device to track a primary audio source using full-body recognition. The instructions can further cause the computing device to remove noise from the audio signals through feedback beamforming. The instructions can cause the computing device to remove noise from the audio signals through auto echo cancellation. The instructions can further cause the computing device to remove noise through beamforming the audio signals originating from the primary audio source. The instructions can further cause the plurality of audio signals to be separated using blind source separation. The instructions can also cause the computing device to remove the noise by applying a delay to one more of the audio signals and summing the audio signals together.

### EXAMPLE 6

A method is described herein. The method includes a means for detecting a plurality of audio signals. The method further includes a means for obtaining depth information and image information and creating a depth map. The method also includes a means for determining a primary audio source from a number of audio sources in the depth map. The method also includes a means for removing noise from the audio signals originating from the primary audio source.

The method can include a means for beamforming the audio signals as received from a plurality of microphones. The method can also include a means for determining and tracking the audio source via a facial recognition mechanism. The method can further include a means for tracking the audio source via a full-body recognition mechanism. The method can also include a means for adjusting the beamforming for movement of a camera as detected via a plurality of accelerometers. The method can also include a means for processing the audio signals using feedback beamforming. The method can further include a means for processing the audio signals using auto echo cancellation. The method can also include a means for separating the audio signals using blind source separation. The method can further include a means for focusing on the primary audio source using beamforming. The primary audio source can be a speaker and the noise can be background voices of other speakers.

In the foregoing description and following claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

It is to be understood that specifics in the aforementioned examples may be used anywhere in one or more embodiments. For instance, all optional features of the computing device described above may also be implemented with respect to either of the methods or the machine-readable medium described herein. Furthermore, although flow diagrams and/or state diagrams may have been used herein to describe embodiments, the present techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A system for noise cancellation, comprising:
a depth sensor;
a plurality of microphones;
a memory that is to store instructions and that is communicatively coupled to the depth sensor and the plurality of microphones; and
a processor communicatively coupled to the depth sensor, the plurality of microphones, and the memory, wherein when the processor is to execute the instructions, the processor is to:
detect audio via the plurality of microphones;
determine, via the depth sensor, a primary audio source from a number of audio sources; and
remove noise from the audio originating from the audio source.

2. The system of claim 1, wherein the processor is to process depth information from the depth sensor to determine the audio sources.

3. The system of claim 1, wherein the processor is to process data from the depth sensor to determine and track the primary audio source by using facial recognition.

4. The system of claim 3, wherein the processor is to further track the primary audio source using full body tracking.

5. The system of claim 1, wherein a noise filter performs de-noising on the audio originating from the audio source.

6. The system of claim 1, wherein the noise is removed using blind source separation.

7. The system of claim 1, wherein the microphones are directional and the primary audio source is focused on using beam forming.

8. The system of claim 1, wherein the depth sensor is inside a depth camera.

9. The system of claim 1, wherein the memory is communicatively coupled to the depth sensor and the plurality of microphones through direct memory access (DMA).

10. The system of claim 1, further comprising an accelerometer, wherein the processor is communicatively coupled to the accelerometer and is to determine relative rotation and translation between the depth sensor and the microphones via the accelerometer.

11. An apparatus for noise cancellation, comprising:
a depth camera;
a plurality of microphones;
logic, at least partially comprising hardware logic, to:
detect audio via the plurality of microphones;
determine a delay of the audio and a sum of the audio as detected by the plurality of microphones;
determine a primary audio source in the audio via the depth camera; and
cancel noise in the primary audio source.

12. The apparatus of claim 11, further comprising logic to determine relative rotation and relative translation between the depth camera and the plurality of microphones.

13. The apparatus of claim 11, further comprising logic to track the primary audio source via the depth camera.

14. The apparatus of claim 13, wherein the logic can track the primary audio source using facial recognition.

15. The apparatus of claim 14, wherein the logic can also track the primary audio source using full-body recognition.

16. The apparatus of claim 11, wherein the apparatus is a laptop, tablet device, or smartphone.

17. A noise cancellation device including at least one camera, wherein the camera is to capture depth information, and at least two microphones, wherein a delay of a sound, to be detected by the at least two microphones, and the depth information is to be processed to identify a primary audio source of the sound and cancel noise from the sound.

18. The noise cancellation device of claim 17, further comprising a beamforming unit to process the sound.

19. The noise cancellation device of claim 17, further comprising a noise cancellation module that is to cancel noise in the sound detected by the at least two microphones.

20. The noise cancellation device of claim 17, wherein the camera is to further capture facial features that are to be used to identify and track the primary audio source of the sound.

21. The noise cancellation device of claim 17, wherein the camera is to further capture a full-body image that is tracked and to be used to identify the primary audio source of the sound.

22. The noise cancellation device of claim 17, further comprising a plurality of accelerometers and a tracking module, wherein the accelerometers are to be used by the tracking module to determine relative rotation and relative translation between the camera and the microphones.

23. A method for noise cancellation, comprising:
detecting a plurality of audio signals;
obtaining depth information and image information and creating a depth map;
determining a primary audio source from a number of audio sources in the depth map; and
removing noise from the audio signals originating from the primary audio source.

24. The method of claim 23, wherein removing noise from the audio signals further comprises beamforming the audio signals as received from a plurality of microphones.

25. The method of claim 24, further comprising determining and tracking the audio source via a facial recognition mechanism.

26. The method of claim 23, further comprising tracking the audio source via a full-body recognition mechanism.

27. The method of claim 23, further comprising adjusting the beamforming for movement of a camera as detected via a plurality of accelerometers.
